(19) United States
(12) Patent Application Publication
(10) Pub. No.: US 2024/0320570 A1
(43) Pub. Date: Sep. 26, 2024

(54) INFORMATION GENERATION DEVICE, INFORMATION GENERATION METHOD, AND INFORMATION GENERATION PROGRAM

(71) Applicant: NEC Corporation, Minato-ku, Tokyo (JP)

(72) Inventors: Riki Eto, Tokyo (JP); Hanae Shimomura, Tokyo (JP); Dai Kubota, Tokyo (JP)

(73) Assignee: NEC Corporation, Minato-ku, Tokyo (JP)

(21) Appl. No.: 18/575,360

(22) PCT Filed: Jul. 13, 2021
(86) PCT No.: PCT/JP2021/026334

§ 371 Date: Dec. 29, 2023

(51) Int. Cl. G06Q 10/04; G06N 20/00

(52) U.S. Cl. CPC G06Q 10/04; G06N 20/00

(57) ABSTRACT

The input means 81 accepts input of first data indicating an optimization problem including an objective function and constraints, and second data indicating a feature of the optimization problem. The generation means 82 generates search information that associates the first data with the second data.

### TECHNICAL FIELD

This invention relates to an information generation device, an information generation method, and an information generation program for generating searchable information.

### BACKGROUND ART

Patent Literature 1 describes a device for selecting one or more machine learning models from multiple machines learning models stored in a database in advance and providing them to a user device in response to a usage request obtained from the user device. The database described in Patent Literature 1 stores multiple machines learning models and also stores model information, which is information on at least one of a function and the generating environment for each machine learning model.

### CITATION LIST

### Patent Literature

PL 1: International Publication 2018/142766

### SUMMARY OF INVENTION

### Technical Problem

The machine learning model described in Patent Literature 1 is assumed to be a predictive model generated by machine learning based on learning data and correct answer data, but it is not assumed that it will be used for decision making such as combinatorial optimization problem.

Therefore, it is an exemplary object of the present invention to provide an information generation device, an information generation method, and an information generation program that can generate information for searching an optimization problem.

### Solution to Problem

An information generation device according to the present invention including: an input means which accepts input of first data indicating an optimization problem including an objective function and a constraint, and second data indicating a feature of the optimization problem; and a generation means which generates search information that associates the first data with the second data.

An information generation method according to the present invention including: accepting input of first data indicating an optimization problem including an objective function and a constraint, and second data indicating a feature of the optimization problem by a computer; and generating search information that associates the first data with the second data by the computer.

An information generation program according to the present invention for causing a computer to execute: input process for accepting input of first data indicating an optimization problem including an objective function and a constraint, and second data indicating a feature of the optimization problem; and generation process for generating search information that associates the first data with the second data.

### Advantageous Effects of Invention

According to the present invention, it is possible to generate information for searching an optimization problem.

### BRIEF DESCRIPTION OF DRAWINGS

FIG. 1 It depicts a block diagram illustrating a configuration example of one exemplary embodiment of an information distribution system according to the present invention.

FIG. 2 It depicts an explanatory diagram showing an example of types of decision-making.

FIG. 3 It depicts a block diagram illustrating a configuration example of an information generation device.

FIG. 4 It depicts an explanatory diagram showing an example of search information.

FIG. 5 It depicts a block diagram illustrating a configuration example of a search device.

FIG. 6 It depicts a flowchart illustrating an operation example of an information generation device.

FIG. 7 It depicts a flowchart illustrating an operation example of a search device 200.

FIG. 8 It depicts a block diagram illustrating a configuration example of one exemplary embodiment of a robot control system.

FIG. 9 It depicts a block diagram illustrating the outline of an information generation device according to the present invention.

FIG. 10 It depicts a schematic block diagram illustrating a configuration of a computer according to at least one of exemplary embodiments.

### DESCRIPTION OF EMBODIMENTS

The following is a description of an exemplary embodiment of the present invention with reference to the drawings.

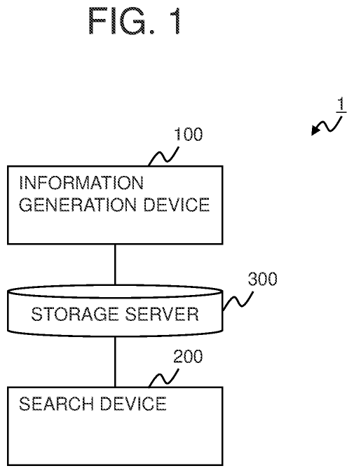

FIG. 1 is a block diagram illustrating a configuration example of one exemplary embodiment of an information distribution system according to the present invention. An information distribution system 1 in this exemplary embodiment includes an information generation device 100, a search device 200, and a storage server 300. The information generation device 100, the search device 200, and the storage server 300 are mutually connected through communication lines.

The information generation device 100 is a device that generates information (hereinafter referred to as “search information”) used by the search device 200, described below; to search for optimization problem. The optimization problem in this exemplary embodiment includes an objective function (more specifically, the structure of the objective function) and constraint conditions formulated for the problem to be solved. Therefore, it can be said that the optimization problem in this exemplary embodiment represents the type of decision-making by a user for the problem to be solved. The method of generating search information is described below.

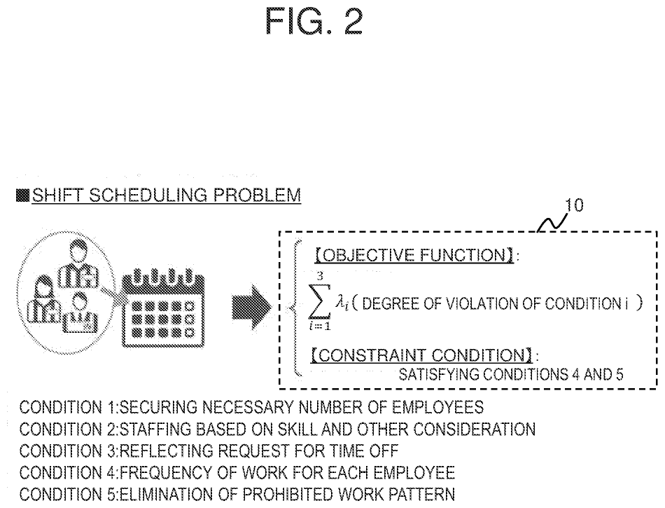

FIG. 2 is an explanatory diagram showing an example of types of decision-making (i.e., the optimization problem). The example shown in FIG. 2 indicates that the type of problem to be solved is classified as a so-called “shift scheduling problem” and that the optimization problem includes an objective function specified by a linear sum of the degrees of violation (explanatory variables) of three conditions (conditions 1, 2, and 3) and two constraint conditions (conditions 4 and 5).

In addition, the objective function λ illustrated in FIG. 2 is a value that indicates the degree to which the user attaches importance to the condition (sometimes also referred to as the user's intention), and is set to various values depending on the type of decision-making. By searching for combinations that minimize the value of this objective function, it becomes possible to derive appropriate actions.

The storage server 300 stores search information generated by the information generation device 100. The storage server 300 may manage the search information using, for example, a general data base (database system). Furthermore, the storage server 300 may store search information generated by a device other than the information generation device 100.

The search device 200 searches for optimization problem using the search information stored in the storage server 300 (more specifically; the database of the storage server 300). The search device 200 also uses the searched optimization problem to derive the optimal action of the user.

Specific configuration examples of the information generation device 100 and the search device 200 will be described below:

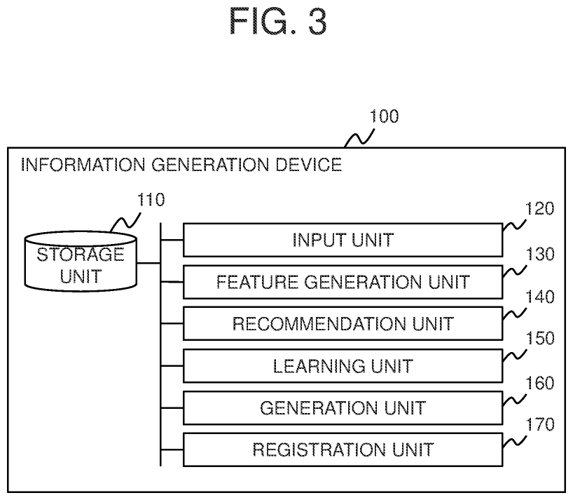

FIG. 3 is a block diagram illustrating a configuration example of an information generation device 100. The information generation device 100 of this exemplary embodiment includes a storage unit 110, an input unit 120, a feature generation unit 130, a recommendation unit 140, a learning unit 150, a generation unit 160, and a registration unit 170.

The storage unit 110 stores various information used by the information generation device 100 to perform processing. The storage unit 110 may store training data, a parameter, learning result, and other information used in the learning process by the learning unit 150 described below: The storage unit 110 is realized by, for example, a magnetic disk.

The input unit 120 accepts input of various types of information used in generating search information. Specifically, the input unit 120 accepts input of information indicating an optimization problem that includes an objective function and a constraint (hereinafter referred to as “first data”), and information indicating a feature of the optimization problem (hereinafter referred to as “second data”).

The input unit 120 may accept input of the first data and the second data from the user. The input unit 120 may also accept input of an objective function generated by the learning unit 150 (more specifically, an objective function stored in the storage unit 110), as described below. The input unit 120 may also accept input of the second data (i.e., information indicating a feature of the optimization problem) from the feature generation unit 130 described below:

In addition, the input unit 120 may accept input of an optimization solver (or information identifying the optimization solver) as a candidate for solving the optimization problem, along with the first data. Examples of optimization solvers include, for example, mathematical programming solver.

For example, a user inputting an optimization problem often understands the appropriate optimization solver to solve that optimization problem. Therefore, by accepting the input of such information along with the first data, it is possible for a user who searches for an optimization problem by using the search device 200, described below; to understand the optimization solver to be used for that optimization problem.

The first data represents information that indicates the optimization problem, such as the structure of the objective function and conditions that indicate constraints, as described above. The form of the objective function is arbitrary. For example, as illustrated in FIG. 2, it may be a function expressed as a linear sum of explanatory variable (condition). The form of the constraint is also arbitrary, and may be information that specifies whether the constraint is satisfied or not by a binary value, or may be information that indicates the degree to which the constraint is satisfied.

The second data can be any content that indicates the feature of the optimization problem. However, the second data need not be information that uniquely identifies the optimization problem. The feature of the optimization problem includes, for example, the type of the optimization problem, attribute information such as the explanatory variable (feature) included, optimization status indicating when, where, who, and what kind of decision is being made, and usage conditions such as the range of available (public) target person and dates.

The type of optimization problem may be a template type of optimization problem, for example, a schedule optimization problem or a knapsack problem, or the type of industry used (e.g., retail, manufacturing, travel, etc.).

The feature generation unit 130 generates feature for the optimization problem. Specifically, the feature generation unit 130 generates the second data described above from the first data. The method by which the feature generation unit 130 generates the second data is arbitrary. The feature generation unit 130 may, for example, automatically generate the second data based on a predetermined method, or may generate the second data based on a designation from the user.

For example, when the objective function is expressed as a linear sum of the explanatory variable described above, the feature generation unit 130 may generate the feature of the optimization problem according to the weight (i.e., the degree of emphasis) of the explanatory variable included in that objective function. For example, the feature generation unit 130 may generate the content of the explanatory variable with the largest weight as a feature of the optimization problem.

Further, for example, when an explanatory variable is explicitly specified by a user (e.g., a feature that is not used in other optimization problems), the feature generation unit 130 may generate the content of that specified explanatory variable as a feature of the optimization problem.

Further, the feature generation unit 130 may specify the type of optimization problem based on the explanatory variable (feature) included in the objective function, and generate the specified type of optimization problem as a feature. For example, it is assumed that the input unit 120 accepts input of an objective function that includes the explanatory variable called “employee work hours”. In this case, the type of optimization problem is more likely to be “shift scheduling” than “order quantity optimization”. This is because “shift scheduling” is more likely to include “employee work hours” as a feature. Therefore, the types of optimization problems according to the explanatory variables may be predetermined, and the feature generation unit 130 may generate the corresponding predetermined type of optimization problem as a feature based on the explanatory variables included in the objective function.

Note that all the features of the generated optimization problem may be included in the search information described below: or the features specified by the user by the recommendation unit 140 described below may be included in the search information described below:

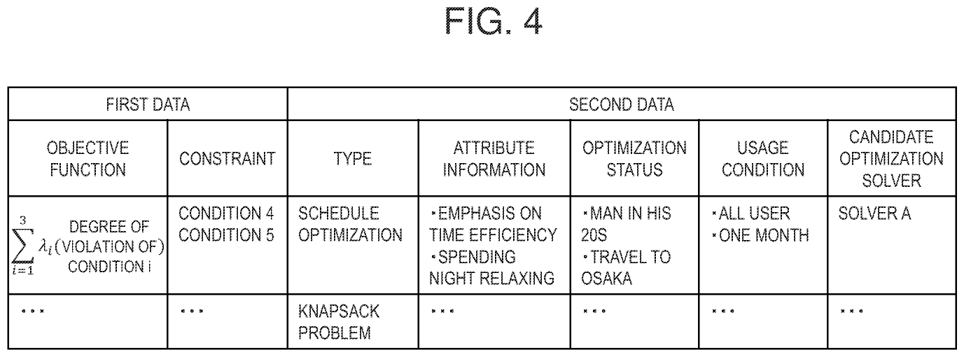

The recommendation unit 140 recommends the feature generated by the feature generation unit 130 to the user. Specifically, the recommendation unit 140 presents the recommended feature to the user and allows the user to specify them. The method in which the recommendation unit 140 presents the feature is arbitrary. For example, the recommendation unit 140 may present content such as the second data illustrated in FIG. 4. Further, the number of features that the recommendation unit 140 allows the user to specify is also not limited, and may be one or more.

The learning unit 150 generates an objective function by machine learning using the training data stored in the storage unit 110. Specifically, the learning unit 150 generates the objective function of the optimization problem (more specifically, the first data) by inverse reinforcement learning using the historical data when the user made a decision (hereinafter referred to as decision-making history data) as training data.

Furthermore, when using a future prediction result, the learning unit 150 may accept input for a prediction model that derives a desired prediction result. The learning unit 150 may then generate the objective function using the prediction result of the accepted prediction model as an explanatory variable. Examples of the future prediction results include product demand prediction, road congestion prediction, and visitor count prediction. If the prediction model is stored in advance in the storage unit 110, the learning unit 150 may acquire the prediction model stored in the storage unit 110.

Here, the feature generation unit 130 may generate, as the second data, information indicating a user who is the basis for generating the training data used to learn the objective function. By using such information, it becomes possible to use the information about the user who made the decision that is the basis for generating the objective function as a feature of the optimization problem.

The learning unit 150 stores the generated objective function in the storage unit 110. Note that if the optimization problem (more specifically: the objective function) has already been generated or if there is no need to learn the objective function, the information generation device 100 does not need to include the learning unit 150.

The generation unit 160 generates search information that associates the first data and the second data. As a result, information for searching an optimization problem can be generated, so that the first data associated with the second data can be searched using that second data as a key.

Further, if the input unit 120 has accepted input of a candidate optimization solver for solving the optimization problem, the generation unit 160 may generate search information including information on the optimization solver. This makes it possible to grasp the optimization solver that can be used for the corresponding optimization problem.

Furthermore, when the recommendation unit 140 accepts a specification of the recommended feature from the user, the generation unit 160 may generate search information including the feature specified by the user in the second data.

The registration unit 170 registers the generated search information with the storage server 300.

FIG. 4 is an explanatory diagram showing an example of search information stored in storage server 300. FIG. 4 shows an example of search information that associates the first data with the second data. For example, the search information shown in the first line indicates that the optimization problem includes an objective function expressed as a linear sum of three conditions (explanatory variables) and two constraint conditions to be satisfied.

Furthermore, in the case of the search information shown in the first line, it indicates that the optimization problem corresponds to the type of so-called “schedule optimization” problem, which is intended to emphasize time efficiency but also emphasize action such as spending the night relaxing. Another optimization problem in the first line relates to the situation of a trip to Osaka by a man in his 20s, and indicates that all users are available for one month. Furthermore, it indicates that “Solver A” is specified as a candidate optimization solver for solving the optimization problem shown in the first line.

Note that the first data does not need to be associated with all of the assumed features as illustrated in FIG. 4, and only some of the features may be associated with the first data. In addition, the classification and expression mode of the feature included in the second data are examples. These features may be expressed, for example, based on the index specifications prescribed in each database.

The input unit 120, the feature generation unit 130, the recommendation unit 140, the learning unit 150, the generation unit 160, and the registration unit 170 are realized by a computer processor (e.g., CPU (Central Processing Unit), GPU (Graphics Processing Unit (GPU)) that operates according to a program (information generation program).

For example, the program may be stored in the storage unit 110 included by the information generation device 100, and the processor may read the program and operate as the input unit 120, the feature generation unit 130, the recommendation unit 140, the learning unit 150, the generation unit 160, and the registration unit 170 according to the program. The functions of the information generation device 100 may be provided in a Saas (Software as a Service) format.

The input unit 120, the feature generation unit 130, the recommendation unit 140, the learning unit 150, the generation unit 160, and the registration unit 170 may each be realized by dedicated hardware. Also, some or all of the components of each device may be realized by general-purpose or dedicated circuits (circuitry), processors, etc., or a combination thereof. They may be configured by a single chip or by multiple chips connected via a bus. Part or all of each component of each device may be realized by a combination of the above-mentioned circuits, etc. and a program.

When some or all of the components of the information generation device 100 are realized by multiple information processing devices, circuits, etc., the multiple information processing devices, circuits, etc. may be centrally located or distributed. For example, the information processing devices and circuits may be realized as a client-server system, a cloud computing system, or the like, each of which is connected via a communication network.

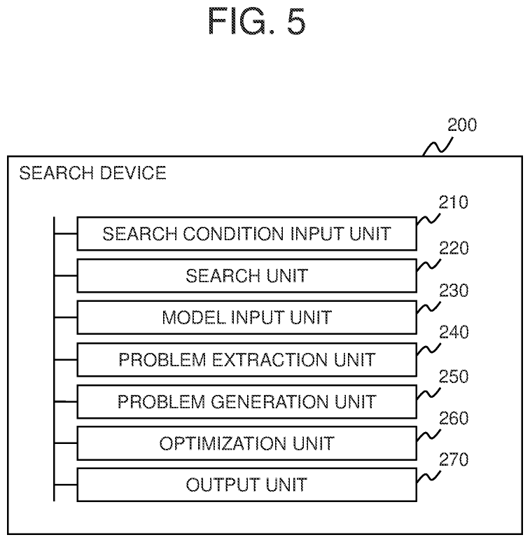

FIG. 5 is a block diagram illustrating a configuration example of the search device 200 of this exemplary embodiment. The search device 200 in this exemplary embodiment includes a search condition input unit 210, a search unit 220, a model input unit 230, a problem extraction unit 240, a problem generation unit 250, an optimization unit 260, and an output unit 270.

The search condition input unit 210 accepts input of a condition for searching optimization problem (hereinafter simply referred to as “search condition”). Specifically, the search condition input unit 210 accepts input of information indicating the feature of the optimization problem (specifically, the second data) as search condition.

The form of information to be input is arbitrary, and the search condition input unit 210 may extract the search condition based on the expected input. For example, the search condition input unit 210 may accept input of a string indicating the content to be solved as an optimization problem. In this case, the search condition input unit 210 may extract the feature of the optimization problem to be extracted from the input string based on known natural language processing. The extracted feature is used by the search unit 220 described below. For example, if the string “I want to create the best plan for a man in his 20s to travel to Osaka.” is entered, the search condition input unit 210 may extract features such as “man in his 20s” and “travel to Osaka” from the entered string.

The search condition input unit 210 may also accept input of information indicating the optimization problem (specifically, information indicating the first data) as a search condition. For example, the search condition input unit 210 may display a list of candidates for the first data indicating the optimization problem and accept specification of the candidates from the user.

The search unit 220 searches for optimization problem from the storage server 300 (more specifically, a database that stores search information that associates the first data with the second data) that match the search condition specified by input to the search condition input unit 210. More specifically, the search unit 220 searches for the first data (i.e., optimization problem) associated with the search information matching the input second data (i.e., feature of the optimization problem).

When information indicating the first data is input, the search unit 220 may search for the optimization problem that match the input information indicating the first data. If the search information includes a candidate for the optimization solver, the search unit 220 may also search for the corresponding optimization solver together.

The search unit 220 may also present the search result to the user and accept the user's desired specification of the optimization problem. For example, the search unit 220 may display the feature of the optimization problem (i.e., the second data) along with the first data as the search result, and accept the user's specification for the displayed first data.

The model input unit 230 accepts input of a model that has been learned based on the target user's decision-making history data (hereinafter sometimes referred to as a decision-making model). In other words, the model input unit 230 accepts input of a model that reflect the target user's past decision-making. The model input unit 230 may also accept input of constraints imposed on the model together with the model.

The method by which the model that accepts input is generated is arbitrary. The model input unit 230 may, for example, accept input of a model that has been learned in a similar way (e.g., inverse reinforcement learning) to the way the learning unit 150 of the information generation device 100 generates the objective function.

The accepted model is compared with the optimization problem searched by the search unit 220. Therefore, the input model is preferably a model generated by a method similar to that of the optimization problem to be searched, or a model generated in a similar manner.

The problem extraction unit 240 compares the optimization problem searched by the search unit 220 with the decision-making model for which the model input unit 230 has accepted input, and extracts the optimization problem from the searched optimization problem (i.e., the first data) that satisfy a predetermined condition of similarity degree with the input decision-making model. The predetermined conditions include, for example, that the similarity degree must be greater than a predetermined threshold value.

Since the decision-making model is a model learned based on the decision-making history data of the target user, it can be said that the model reflects the intentions of the target user. The problem extraction unit 240 determines the similarity degree between such a model and an optimization problem, thereby making it possible to extract an optimization problem that reflects intentions similar to the target user.

The method by which the problem extraction unit 240 calculates the similarity degree is arbitrary. The problem extraction unit 240 may calculate the similarity degree of the features (explanatory variables) included in each of the decision-making model and optimization problem. For example, the problem extraction unit 240 may calculate the degree of overlap of feature types as the similarity degree. Otherwise, the problem extraction unit 240 may calculate the similarity by calculating the difference in the values of the weight coefficients of each of the overlapping feature, for example, by cosine similarity degree or RMSE (Root Mean Square Error).

Furthermore, if there is training data used in generating the decision-making model and optimization problem, the problem extraction unit 240 may calculate the degree of overlap of the range of possible value ranges in the same feature and the mean or variance of each feature as similarity degree.

The method by which the problem extraction unit 240 calculates similarity degree is not limited to the method based on the structure of the decision-making model and optimization problem, as described above. The problem extraction unit 240 may, for example, calculate similarity degree based on the difference in output values when the same data is input to each of the decision-making model and optimization problem. If the optimization problem and the decision-making model are each assigned sentences that indicate characteristics of the problem or model, the problem extraction unit 240 may calculate the similarity degree between each sentence as the similarity degree between the optimization problem and the decision-making model.

The search device 200 does not necessarily need to accept input of a decision-making model. If there is no decision-making model input, the search device 200 need not include the model input unit 230 and the problem extraction unit 240.

In cases where multiple optimization problems are extracted, the problem generation unit 250 generates a new objective function from the extracted multiple optimization problems. Specifically, the problem generation unit 250 generates a new objective function by combining two or more objective functions selected from the multiple optimization problems. If one optimization problem is identified, the problem generation unit 250 does not need to generate a new objective function.

Here, combining two or more objective functions means that extracting some or all of the explanatory variables included in each objective function respectively based on predetermined rule, and formulating (functionalizing) them using the extracted explanatory variables. The rule is defined by the user, etc., according to the degree to which each objective function reflects the intention expressed. The predetermined rule includes, for example, multiplying the weights of the original explanatory variables by a predetermined percentage and then extracting all of them, and then calculating the sum of each of the extracted explanatory variables.

The following is a specific example of combining objective functions. For example, it is assumed that objective function A and objective function B include multiple overlapping features f₁, f₂, and f₃ as shown below:

$${a}_{{1}^{*}} {f}_{1} + {a}_{{2}^{*}} {f}_{2} + {a}_{{3}^{*}} {f}_{3} \qquad Objective function A$$

$${b}_{{1}^{*}} {f}_{1} + {b}_{{2}^{*}} {f}_{2} + {b}_{{3}^{*}} {f}_{3} \qquad Objective function B$$

Here, assume a situation where it is desired to generate an objective function that will indicates an intention intermediate between the intention indicated by objective function A and the intention indicated by objective function B (i.e., an intention that reflects both intentions equally). In this case, the problem generation unit 250 may generate objective function C as shown below by adding together the objective functions with each coefficient of each explanatory variable multiplied by 0.5 so that the combination ratio is 1:1.

$$0.5 * ( {a}_{1} + {b}_{1} ) * {f}_{1} + 0.5 * ( {a}_{2} + {b}_{2} ) * {f}_{2} + 0.5 * ( {a}_{3} + {b}_{3} ) * {f}_{3} \qquad Objective function C$$

Similarly, assume a situation where it is desired to generate an objective function that will reflect the intention indicated by objective function A more than the intention indicated by objective function B. In this case, the problem generation unit 250 may combine the objective variables so that the combination ratio is, for example, 4:1, and generate an objective function D as shown below:

$$( 0.8 * {a}_{1} + 0.2 * {b}_{1} ) * {f}_{1} + ( 0.8 * {a}_{2} + 0.2 * {b}_{2} ) * {f}_{2} + ( 0.8 * {a}_{3} + 0.2 * {b}_{3} ) * {f}_{3} \qquad Objective function D$$

The optimization unit 260 performs optimization processing based on the new objective function generated and derives an optimization result. Further, for example, if a candidate optimization solver is specified, the optimization unit 260 may derive the optimization result using the specified optimization solver.

The output unit 270 outputs the optimization result (e.g., optimal action) derived by the optimization unit 260.

The search condition input unit 210, the search unit 220, the model input unit 230, the problem extraction unit 240, the problem generation unit 250, the optimization unit 260, and the output unit 270 are realized by a computer processor operating according to a program (search program).

For example, the program may be stored in a storage unit (not shown) included in the search device 200, and the processor may read the program and operates as the search condition input unit 210, the search unit 220, the model input unit 230, the problem extraction unit 240, the problem generation unit 250, the optimization unit 260, and the output unit 270 according to the program. The function of the search device 200 may be provided in a Saas (Software as a Service) format.

Similar to the configuration of the information generation device 100, the search condition input unit 210, the search unit 220, the model input unit 230, the problem extraction unit 240, the problem generation unit 250, the optimization unit 260, and the output unit 270 may each be realized in dedicated hardware.

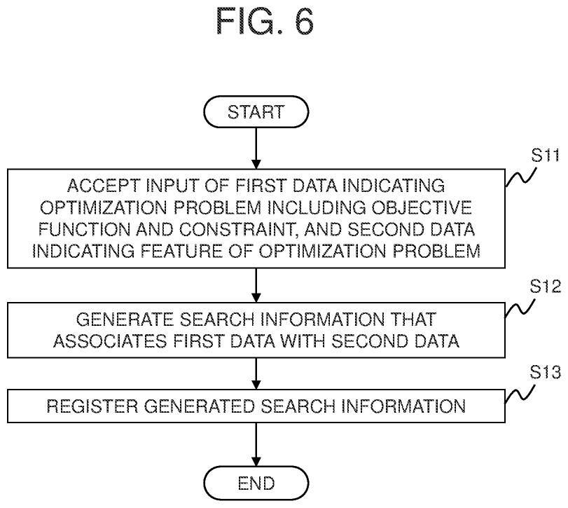

Next, the operation of the information distribution system 1 of this exemplary embodiment will be described. FIG. 6 is a flowchart illustrating an operation example of the information generation device 100 of this exemplary embodiment. The input unit 120 accepts input of the first data indicating an optimization problem including an objective function and constraints, and the second data indicating a feature of the optimization problem (step S11). The generation unit 160 generates search information that associates the first data with the second data (step S12). The registration unit 170 registers the generated search information with the storage server 300 (step S13).

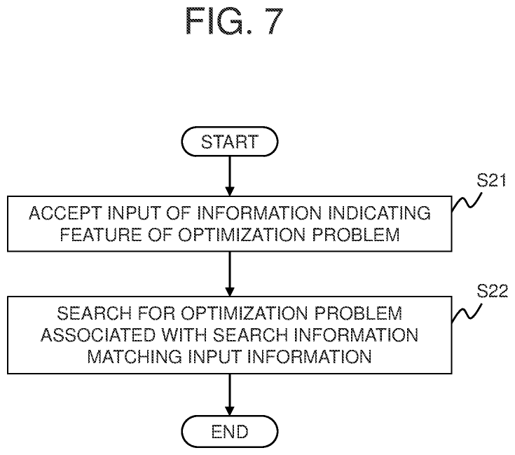

FIG. 7 is a flowchart illustrating an operation example of the search device 200 of this exemplary embodiment. The search condition input unit 210 accepts input of information (i.e., the second data) indicating the feature of the optimization problem (step S21). The search unit 220) searches from the storage server 300 for the optimization problem (i.e., the first data) associated with the search information matching the input information (i.e., the second data) (step S22). Thereafter, the optimization unit 260 performs optimization processing using the searched first data, and the output unit 270 outputs the optimization result.

As described above, in this exemplary embodiment, the input unit 120 accepts input of the first data and the second data, and the generation unit 160 generates search information that associates the first data with the second data. Thus, information for searching optimization problem can be generated.

In other words, as described above, the optimization problem is generally generated individually considering the user's point of view and various constraint conditions, so the technical concept of storing multiple optimization problems in a searchable manner in a database or the like did not exist. On the other hand, in this exemplary embodiment, the generation unit 160 generates search information that associates the first data with the second data, making it possible to manage the optimization problem using this search information.

Moreover, in this exemplary embodiment, the search condition input unit 210 accepts input of second data as a search condition, and the search unit 220 searches for the first data associated with the search information matching the input second data from the storage server 300. Thus, the desired optimization problem can be searched.

In other words, as described above, due to the characteristic of the individually generated optimization problem, the technical concept of searching other optimization problem from the database did not exist. On the other hand, in this exemplary embodiment, the search unit 220 searches for the first data associated with the search information matching the input second data from the storage server 300. Thus, it is possible to obtain the desired optimization problem.

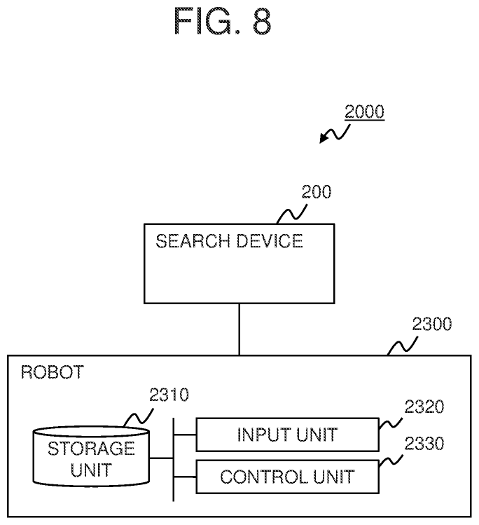

Next, a specific example of a robot control system using the search device 200 of this exemplary embodiment will be described. FIG. 8 is a block diagram illustrating a configuration example of one exemplary embodiment of the robot control system. A robot control system 2000 illustrated in FIG. 8 includes a search device 200 and a robot 2300.

The search device 200 illustrated in FIG. 8 is the same as the search device 200 in the above exemplary embodiment. The search device 200 stores the optimization result in a storage unit 2310 of the robot 2300, which will be described later.

The robot 2300 is equipment that operates based on the optimization result. The robot here is not limited to device shaped to resemble human or animal, but also include devices that perform automatic tasks (automatic operation, automatic control, etc.). The robot 2300 includes the storage unit 2310, an input unit 2320, and a control unit 2330.

The storage unit 2310 stores the optimization result derived by the search device 200.

The input unit 2320 accepts input of various information used to operate the robot.

The control unit 2330 controls the operation of the robot 2300 based on the various information accepted and the optimization result stored in the storage unit 2310. The method by which the control unit 2330 controls the operation of the robot 2300 based on the optimization result may be predetermined. In this exemplary embodiment, equipment that performs automatic tasks, such as the robot 2300, can be controlled based on the derived optimization result.

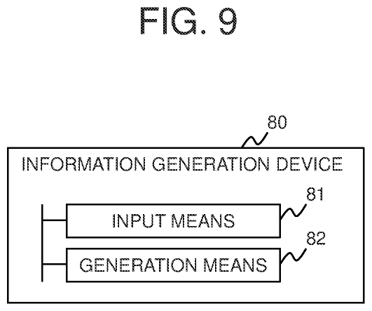

The following is an overview of this invention. FIG. 9 is a block diagram illustrating the outline of an information generation device according to the present invention. An information generation device 80 (e.g., the information generation device 100) according to the present invention includes an input means 81 (e.g., the input unit 120) which accepts input of first data indicating an optimization problem including an objective function and a constraint, and second data indicating a feature of the optimization problem, and a generation means 82 (e.g., the generation unit 160) which generates search information that associates the first data with the second data.

Such a configuration can generate information for searching an optimization problem. The generation means 82 may also generate the search information that associates the first data including the objective function learned using the target person's decision-making history data, with the second data.

The information generation device 80 may also include a feature generation means (e.g., the feature generation unit 130) which generates a feature of the optimization problem. The generation means 82 may then generate search information that associates the feature of the generated optimization problem with the first data.

The objective function may be expressed as a linear sum of an explanatory variable. In this case, the feature generation means may generate the feature of the optimization problem according to weights of the explanatory variable included in the objective function. The feature generation means may also generate information indicating a user who was a

basis for generating training data used to learn the objective function as the feature of the optimization problem.

The information generation device 80 may also include a recommending means (e.g., the recommendation unit 140) which recommends the feature generated by the feature generation means to a user. The recommending means may present the features to be recommended to the user and allows the user to specify the feature, and the generation means 82 may generate search information including the feature specified by the user in the second data.

The input means 81 may also accept input of information on candidate optimization solver for solving the optimization problem. The generation means 82 may then generate search information including the information on the optimization solver.

The information generation device 80 may include a learning means (e.g., the learning unit 150) which generates an objective function for an optimization problem by inverse reinforcement learning using target person's decision-making history data. The generation means 82 may then generate search information that associates the first data including the generated objective function with the second data.

In this case, the learning unit may accept input for a prediction model and generate the objective function using a prediction result of the accepted prediction model as an explanatory variable.

The information generation device 80 may also include a registration means (e.g., the registration unit 170) which registers the generated search information in a database (e.g., storage server 300).

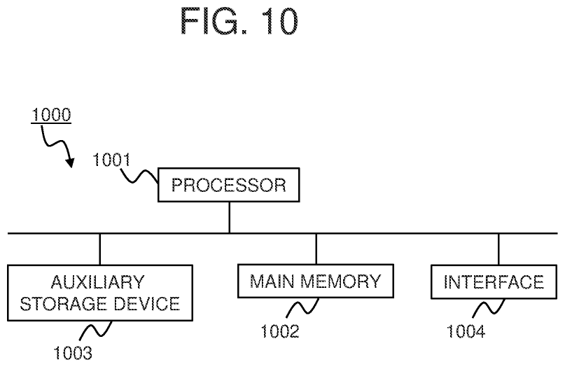

FIG. 10 is a schematic block diagram illustrating a configuration of a computer according to at least one of exemplary embodiments. A computer 1000 includes a processor 1001, a main storage device 1002, an auxiliary storage device 1003, and an interface 1004.

Each of the devices (the information generation device 100 and the search device 200) of the information distribution system 1 described above is implemented in the computer 1000. The operation of each processing unit described above is stored in the auxiliary storage device 1003 in the form of a program. The processor 1001 reads the program from the auxiliary storage device 1003, expands it in the main storage device 1002, and executes the above processing according to the program.

In at least one exemplary embodiment, the auxiliary storage device 1003 is an example of a non-temporary tangible medium. Other examples of non-transient tangible medium include a magnetic disk, a magneto-optical disk, a CD-ROM (Compact Disc Read-only memory), a DVD-ROM (Read Read-only memory), a semiconductor memory, etc., connected via interface 1004. Furthermore, in a case where the program is distributed to the computer 1000 via a communication line, the computer 1000 that has received the program may develop the program in the main storage device 1002 and execute the above processing.

Furthermore, the program may be for implementing some of the functions described above. In addition, the program may be a program that implements the above-described functions in combination with another program already stored in the auxiliary storage device 1003, a so-called difference file (difference program).

Although some or all of the above exemplary embodiments may also be described as in the following Supplementary notes, but not limited to the following.

(Supplementary note 1) An information generation device comprising:
an input means which accepts input of first data indicating an optimization problem including an objective function and a constraint, and second data indicating a feature of the optimization problem; and
a generation means which generates search information that associates the first data with the second data.

(Supplementary note 2) The information generation device according to Supplementary note 1, wherein
the generation means generates the search information that associates the first data including the objective function learned using target person's decision-making history data, with the second data.

(Supplementary note 3) The information generation device according to Supplementary note 1 or 2, further comprising:
a feature generation means which generates a feature of the optimization problem,
wherein the generation means generates search information that associates the feature of the generated optimization problem with the first data.

(Supplementary note 4) The information generation device according to Supplementary note 3, wherein
the objective function is expressed as a linear sum of an explanatory variable, and
the feature generation means generates the feature of the optimization problem according to weights of the explanatory variable included in the objective function.

(Supplementary note 5) The information generation device according to Supplementary note 3 or 4, wherein
the feature generation means generates information indicating a user who was a basis for generating training data used to learn the objective function as the feature of the optimization problem.

(Supplementary note 6) The information generation device according to any one of Supplementary note 3 to 5, further comprising:
a recommendation means which recommends the feature generated by the feature generation means to a user,
wherein the recommendation means presents the feature to be recommended to the user and allows the user to specify the feature, and
wherein the generation means generates search information including the feature specified by the user in the second data.

(Supplementary note 7) The information generation device according to any one of Supplementary note 1 to 6, wherein
the input means accepts input of information on candidate optimization solver for solving the optimization problem, and
the generation means generates search information including the information on the optimization solver.

(Supplementary note 8) The information generation device according to any one of Supplementary note 1 to 7, further comprising
a learning means which generates an objective function for an optimization problem by inverse reinforcement learning using target person's decision-making history data,
wherein the generation means generates search information that associates the first data including the generated objective function with the second data.

(Supplementary note 9) The information generation device according to Supplementary note 8, wherein
the learning means accepts input of a prediction model and generates the objective function using a prediction result of the accepted prediction model as an explanatory variable.

(Supplementary note 10) The information generation device according to any one of Supplementary note 1 to 9, further comprising a registration means which registers the generated search information in a database.

(Supplementary note 11) An information generation method comprising:
accepting input of first data indicating an optimization problem including an objective function and a constraint, and second data indicating a feature of the optimization problem by a computer; and
generating search information that associates the first data with the second data by the computer.

(Supplementary note 12) The information generation method according to Supplementary note 11, further comprising
generating the search information that associates the first data including the objective function learned using target person's decision-making history data, with the second data by the computer.

(Supplementary note 13) A program storage medium for storing an information generation program for causing a computer to execute:
input process for accepting input of first data indicating an optimization problem including an objective function and a constraint, and second data indicating a feature of the optimization problem; and
generation process for generating search information that associates the first data with the second data.

(Supplementary note 14) The program storage medium for storing the information generation program according to Supplementary note 13, for causing the computer to further execute:
to generate the search information that associates the first data including the objective function learned using target person's decision-making history data, with the second data in the generation process.

(Supplementary note 15) An information generation program for causing a computer to execute:
input process for accepting input of first data indicating an optimization problem including an objective function and a constraint, and second data indicating a feature of the optimization problem; and
generation process for generating search information that associates the first data with the second data.

(Supplementary note 16) The information generation program according to Supplementary note 15, for causing the computer to further execute:
to generate the search information that associates the first data including the objective function learned using target person's decision-making history data, with the second data in the generation process.

### REFERENCE SIGNS LIST

1 Information distribution system
100 Information generation device
110 Storage unit
120 Input unit
130 Feature generation unit
140 Recommendation unit
150 Learning unit
160 Generation unit
170 Registration unit
200 Search device
210 Search condition input unit
220 Search unit
230 Model input unit
240 Problem extraction unit
250 Problem generation unit
260 Optimization unit
270 Output unit
300 Storage server

What is claimed is:

1. An information generation device comprising:
a memory storing instructions; and
one or more processors configured to execute the instructions to:
accept input of first data indicating an optimization problem including an objective function and a constraint, and second data indicating a feature of the optimization problem; and
generate search information that associates the first data with the second data.

2. The information generation device according to claim 1, wherein the processor is configured to execute the instructions to generate the search information that associates the first data including the objective function learned using target person's decision-making history data, with the second data.

3. The information generation device according to claim 1, wherein the processor is configured to execute the instructions to:
generate a feature of the optimization problem; and
generate search information that associates the feature of the generated optimization problem with the first data.

4. The information generation device according to claim 3, wherein
the objective function is expressed as a linear sum of an explanatory variable, and
the processor is configured to execute the instructions to generate the feature of the optimization problem according to weights of the explanatory variable included in the objective function.

5. The information generation device according to claim 3, wherein the processor is configured to execute the instructions to
generate information indicating a user who was a basis for generating training data used to learn the objective function as the feature of the optimization problem.

6. The information generation device according to claim 3, wherein the processor is configured to execute the instructions to:
present the generated feature to be recommended to the user and allow the user to specify the feature; and
generate search information including the feature specified by the user in the second data.

7. The information generation device according to claim 1, wherein the processor is configured to execute the instructions to:
accept input of information on candidate optimization solver for solving the optimization problem; and
generate search information including the information on the optimization solver.

8. The information generation device according to claim 1, wherein the processor is configured to execute the instructions to:
generate an objective function for an optimization problem by inverse reinforcement learning using target person's decision-making history data; and
generate search information that associates the first data including the generated objective function with the second data.

9. The information generation device according to claim 8, wherein the processor is configured to execute the instructions to accept input of a prediction model and generate the objective function using a prediction result of the accepted prediction model as an explanatory variable.

10. The information generation device according to claim 1, wherein the processor is configured to execute the instructions to register the generated search information in a database.

11. An information generation method comprising:
accepting input of first data indicating an optimization problem including an objective function and a constraint, and second data indicating a feature of the optimization problem by a computer; and
generating search information that associates the first data with the second data by the computer.

12. The information generation method according to claim 11, further comprising
generating the search information that associates the first data including the objective function learned using target person's decision-making history data, with the second data by the computer.

13. A non-transitory computer readable information recording medium storing an information generation program, when executed by a processor, that performs a method for:
accepting input of first data indicating an optimization problem including an objective function and a constraint, and second data indicating a feature of the optimization problem; and
generating search information that associates the first data with the second data.

14. The non-transitory computer readable information recording medium according to claim 13,
wherein the search information that associates the first data including the objective function learned using target person's decision-making history data, with the second data is generated.
